(19) United States
(12) Patent Application Publication
(10) Pub. No.: US 2022/0021541 A1
(43) Pub. Date: Jan. 20, 2022

(54) AN ONLINE AND OFFLINE CIRCULATING UNBALANCED OIL AND VINEGAR SIGNATURE METHOD

(71) Applicant: SOUTH CHINA UNIVERSITY OF TECHNOLOGY, Guangdong (CN)

(72) Inventors: Shaohua TANG, Guangdong (CN); Zhiniang PENG, Guangdong (CN); Dongxiang FANG, Guangdong (CN)

(21) Appl. No.: 16/768,599

(22) PCT Filed: Oct. 29, 2018
(86) PCT No.: PCT/CN2018/112441

§ 371 Date: May 29, 2020

(30) Foreign Application Priority Data
Dec. 1, 2017 (CN) 201711248962.9

(51) Int. Cl. H04L 9/32; H04L 9/08; G06F 17/16

(52) U.S. Cl. CPC H04L 9/3247; G06F 17/16; H04L 9/0866; H04L 9/0825

(57) ABSTRACT

The present invention discloses an online and offline circulating unbalanced oil and vinegar signature method, which decomposes the traditional unbalanced oil and vinegar signature process into offline and online parts, wherein the offline step is independent of the signature message, and can be performed in advance, and a combination of circulating calculation methods is used in the calculating process to improve performance. When the online part needs to be signed, the final signature operation is completed by using the calculated result stored in the offline step. The present invention is a multi-variable public key cryptosystem-based unbalanced oil and vinegar signature scheme, which is a lightweight digital signature scheme suitable for low-performance electronic devices. The invention decomposes the unbalanced oil and vinegar signature algorithm into offline and online parts, and the offline step calculation can be performed in advance, which can more fully utilize energy and accelerate the online signature process simultaneously. In the calculation of the offline step, the present invention uses a circulating calculation method, which greatly reduces the size of the secret key and shortens the signature period.

### FIELD OF THE INVENTION

The invention relates to the technical field of information security, in particular to an online and offline circulating unbalanced oil and vinegar signature method.

### BACKGROUND OF THE INVENTION

Cryptography is the core and foundation of information security and is widely used in network communications, e-commerce, banking, defense and military. The cryptographic techniques include symmetric ciphers and asymmetric ciphers, which are also known as public key ciphers.

As an important technique in cryptography to protect the authenticity of data, digital signature technique is almost ubiquitous. In addition to servers, personal computers, smart phones and other high-performance devices that use digital signature technique to protect data security, there are many low-performance electronic devices that also require digital signature technique to ensure data security. For example, Wireless Sensor Networks (WSN) is a distributed sensor network. At its end is a sensor that senses and examines the outside world. Due to its low cost and wide applicability, it is widely used in commercial and industrial applications. In some WSN applications, the correctness of the transmitted data is critical. For example, in a patient condition monitoring system, the patient's critical physiological information can cause irreparable damage if it is tampered with. Unfortunately, low-performance electronic devices like wireless sensor devices typically have limited computing power, have small storage space, and are sensitive to power consumption requirements. Traditional digital signature schemes such as ECDSA, RSA, etc. are not suitable for such devices because of high energy consumption and long signature delay. Designing a lightweight, energy-efficient digital signature scheme is currently a very valuable research direction.

The unbalanced Oil and Vinegar Signature is an important application of multivariate public key cryptosystem (MPKC) in the field of digital signatures. The basic structure of the unbalanced oil and vinegar signature is the oil and vinegar polynomial. The polynomial contains oil and vinegar variables. After selecting the values of all the vinegar variables, the oil and vinegar polynomial becomes a linear polynomial about the oil variable. One oil and vinegar polynomial set can produce a signature. The unbalanced oil and vinegar signature itself is a lightweight signature scheme for those lower performing electronic devices. However, the traditional unbalanced oil and vinegar signature schemes still have some shortcomings, such as a long key length, which cannot fully utilize the ability of some electronic devices to collect energy. These shortcomings have led to poor performance of the signature schemes on low performance electronic devices.

Therefore, it is urgent to propose an online and offline circulating unbalanced oil and vinegar signature method.

### SUMMARY OF THE INVENTION

The object of the present invention is to solve the above-mentioned drawbacks in the prior art, and to provide an online and offline circulating unbalanced oil and vinegar signature method.

The object of the present invention can be achieved by adopting the following technical solutions:

An online and offline circulating unbalanced oil and vinegar signature method, wherein the online and offline circulating unbalanced oil and vinegar signature method comprises:

offline step: before a signature message arrives, using an energy that cannot be stored at a peak of energy collection by a device to calculate in advance and store intermediate results. Using the circulating calculation method to construct the central mapping matrix, and using the fast inversion method based on the circulant matrix to obtain the inverse matrix; the calculation process comprises: selecting secret parameters, calculating the central mapping matrix and its inverse matrix, generating the public key and the private key and storing calculation results;

online step: when the signature message arrives, performing the calculation in combination with the results stored in the offline step; the calculation process comprises: signature message preprocessing, signature operation, and signature verification.

Further, the described constructing the central mapping matrix using the circulating calculation method comprises the following steps:

first, calculating the first row of the matrix G by v*B₁+β₁, where v is the vinegar variable, B₁ is the cross-term coefficient of the vinegar variable and the oil variable, and β₁ is the linear term coefficient of the oil variable; then obtaining a complete circulant matrix G by rotating (B₁,β₁).

Further, the described fast inversion method based on the circulant matrix to solve the inverse matrix comprises the following steps:

first, writing the polynomial form f x)=Σᵢ₌ₒ^{o-1}lᵢxᵢ of the circulant matrix G; then using the extended Euclidean algorithm to find the inverse element g(x) of f(x) on the polynomial ring K[x]/(x^{o}−1); finally, re-presenting g(x) as the matrix form.

Further, the described offline step that is used for offline key generation, specifically as follows:

S101. first, according to the required security level, select the base field K=GF(q), the number of oil variables o, the number of vinegar variables v, and the reversible affine R and S, let n=o+v;

S102. convert the central mapping equation of the unbalanced oil and vinegar signature, and decompose into the form that can be calculated online and offline;

S103. perform the circulating calculation method, including selecting the vinegar vector v, calculate the circulant matrix G, and solve the inverse matrix G⁻¹ of G as the polynomial form g(x), and calculate the constant term vector y;

S104. calculate the composite map P=S [symbol] G [symbol] R [symbol] Kⁿ→K^{o} as the public key and store it for verifying the signature process, where Kⁿ→K^{o} denotes a representation of the mapping from n dimension vector to o dimension vector on the base field K;

S105. calculate inverse matrices of the reversible affine R and S, store (R⁻¹,S⁻¹) and other basic parameters as the private key, which will be used in the signature process;

S106. finally store (v, y, g(x)) in the memory and complete the offline step calculation.

Further, using the described online step for online signature generation and online signature verification; wherein the specific process of online signature generation is as follows:

S201. first, calculate the hash value h(m)∈K^{o} of the message m, and then calculate m′=h(m)−y, where K^{o} denotes the o dimension vector on the base field K=GF(q), and o denotes the number of oil variables;

S202. act inverse affine S⁻¹ to m′, get u=S⁻¹(m′), and obtain its related polynomial u(x);

S203. obtain the solution (\hat{x}₁, . . . , \hat{x}ₒ) of the central mapping oil variable by calculating u(x)*g(x), wherein g(x) is the polynomial form of the inverse matrix Gr⁻¹ of the circulant matrix G;

S204. splice the vinegar variable (v₁, . . . , vᵥ), which are selected in the offline calculation stage, and the solution (\hat{x}₁, . . . , \hat{x}ₒ) of the oil variable, to get \hat{x}=(x₁, . . . , xₙ), wherein n=o+v;

S205. act inverse affine R⁻¹ to \hat{x}, get s=R⁻¹(\hat{x}), output the signature s∈Kⁿ;

Among them, the specific process of online signature verification is as follows:

S206. the signer sends the message signature pair (m,s) to the verifier;

S207. the verifier uses the public key P to calculate whether P(s) is equal to h(m)−y to verify the correctness of the signature; if they are equal, the signature is legal; otherwise, the signature is illegal.

Further, the described step S102, converts the central mapping equation of the unbalanced oil and vinegar signature, and decomposes into the online and offline calculation form, specifically comprises the following steps:

S102a. first unfold the unbalanced oil and vinegar central mapping equation and express it as:

$$\underbrace{{v}^{T} * {A}_{k} * v + {v}^{T} \cdot {α}_{k} + {c}_{k}}_{constant} + \underbrace{{v}^{T} * {B}_{k} * o + {β}_{k} \cdot o}_{linear in o} = {m}_{k} , \\ v ∈ {K}^{v} , o ∈ {K}^{o} , k = 1 , 2 , … o ;$$

S102b. let yₖ=(v^{T}*Aₖ*v+v^{T}·αₖ+cₖ),k∈[1, 2, . . . , o], substitute the vinegar variable into the oil and vinegar equation, then express the unbalanced oil and vinegar signature central mapping equation as Gₒ=u:

$$\underbrace{( \begin{matrix}{v}^{T} * {B}_{1} + {β}_{1} \\ {v}^{T} * {B}_{2} + {β}_{2} \\ ⋮ \\ {v}^{T} * {B}_{o - 1} + {β}_{o - 1} \\ {v}^{T} * {B}_{o - 1} + {β}_{o - 1}\end{matrix} )}_{G} ( \begin{matrix}{o}_{1} \\ {o}_{2} \\ ⋮ \\ {o}_{o - 1} \\ {o}_{o}\end{matrix} ) = \underbrace{( \begin{matrix}{m}_{1} \\ {m}_{2} \\ ⋮ \\ {m}_{o - 1} \\ {m}_{0}\end{matrix} ) - ( \begin{matrix}{y}_{1} \\ {y}_{2} \\ ⋮ \\ {y}_{o - 1} \\ {y}_{o}\end{matrix} )}_{u} .$$

Further, the described step S103, in the execution of circulating calculation method, the circulating calculation method specifically comprises the following steps:

S103a. first select the set of vinegar variables (v₁, . . . , vᵥ);

S103b. get the first row of the matrix G by calculating v*B₁+β₁, and then obtain the complete circulant matrix G by rotating (B₁, β₁);

S103c. write the polynomial form of the circulant matrix G, f(x)=Σᵢ₌ₒ^{o-1}lᵢxᵢ;

S103d. use an extended Euclidean algorithm to find the inverse element g(x) of f(x) on the polynomial ring K[x]/(x^{o}−1), and then re-present g(x) as the matrix form G⁻¹; if the inverse element g(x) does not exist, indicating that the matrix G is irreversible, then return to step S103a to re-select the vinegar variable v;

S103e. according to an effective vinegar variable v, calculate yₖ=(v^{T}*Aₖ*v+v^{T}·αₖ+cₖ)(k∈[1, . . . , o]) to get the constant term vector y.

The present invention has the following advantages and effects over the prior art:

1. The online and offline circulating unbalanced oil and vinegar signature method used in the present invention is the signature algorithm based on the multivariate public key cryptosystem. Compared with other popular commercial signature algorithms, this scheme requires fewer computing resources and is safe and reliable. Therefore, it can be applied to devices with lower performance.

2. While ensuring the security of the signature, the present invention fully utilizes the characteristics that many devices can automatically collect energy, and uses the energy exceeding the capacity at the peak of energy collection for the calculation of the offline step. Through this pre-calculation method, not only the energy utilization rate is improved, but also the speed of the signature is increased, which is more in line with the requirements of the communication system with strict latency requirements.

3. In the offline step calculation process, the present invention uses the circulating calculation method, which greatly reduces the key length required in the signature algorithm, reduces the requirement on the device memory, and shortens the signature period.

### BRIEF DESCRIPTION OF THE DRAWINGS

FIG. 1 is a flow chart of the algorithm for the online and offline circulating unbalanced oil and vinegar signature method disclosed by the present invention.

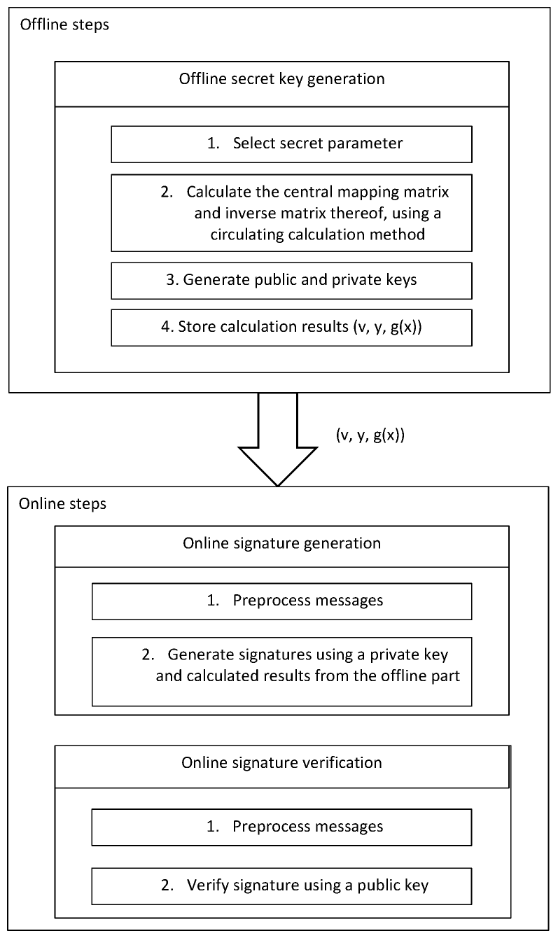

### DETAILED DESCRIPTION

In order to make the objects, technical solutions and advantages of the embodiments of the present invention clearer, the technical solutions in the embodiments of the present invention will be clearly and completely described in conjunction with the drawings in the embodiments of the present invention. It is obviously a partial embodiment of the invention, and not all of the embodiments. Based on the embodiments of the present invention, all other embodiments obtained by those skilled in the art without creative efforts are within the scope of the present invention.

### Embodiment

This embodiment discloses the online and offline circulating unbalanced oil and vinegar signature method, and the wireless sensing network to which the method is applied can automatically collect energy.

The unbalanced oil and vinegar signature process is broken down into two main steps:

offline step: The offline step is independent of the message that needs to be signed and is pre-executed before signing. This step uses the wireless sensor network to calculate the energy that cannot be stored at the peak of energy harvesting. The main calculation process comprises: selecting secret parameters, calculating the central mapping matrix and its inverse matrix, generating of public and private keys, and storage of calculation results.

online step: The online step is related to the message that needs to be signed. This step is performed in conjunction with the results stored in the offline step when the signature message arrives. The main calculation process comprises: signature message preprocessing, signature operation, and signature verification.

The offline step can be calculated using the excess energy that the wireless sensor network can't continue to store at the peak of energy harvesting.

The offline step uses the circulating calculation method to construct the central mapping matrix and uses the fast inversion of the circulant matrix method to solve its inverse matrix.

Wherein, using the circulating calculation method to construct the central mapping matrix specifically comprises the following steps: first, calculating the first row of the matrix G by v*B₁+β₁, where v is the vinegar variable, B₁ is the cross-term coefficient of the vinegar variable and the oil variable, and β₁ is a linear term coefficient of the oil variable; then obtaining a complete circulant matrix G by rotating (B₁,β₁).

Wherein, using the fast inversion method of the circulant matrix to solve the inverse matrix specifically comprises the following steps: first writing the polynomial form f(x)=Σᵢ₌ₒ^{o-1}lᵢxᵢ of the circulant matrix G; then using the extended Euclidean algorithm to find the inverse element g(x) of f(x) on the polynomial ring K[x]/(x^{o}−1); finally, re-presenting g(x) as a matrix form G⁻¹.

The online and offline circulating unbalanced oil and vinegar signature method comprises the following sequence of steps:

S1, offline step, for offline key generation;

S101. first, according to the required security level, select the base field K=GF(q), the number of oil variables o, the number of vinegar variables v, and the reversible affine R and S, let n=o+v;

S102. convert the central mapping equation of the unbalanced oil and vinegar signature, and decompose into the form that can be calculated online and offline;

S103. perform the circulating calculation method, including selecting the vinegar vector v, calculate the circulant matrix G, and solve the inverse matrix G⁻¹ of G as the polynomial form g(x), and calculate the constant term vector y;

S104. calculate the composite map P=S [symbol] G [symbol] R [symbol] Kⁿ→K^{o} as the public key and store it for verifying the signature process, where Kⁿ→K^{o} denotes a representation of the mapping from n dimension vector to o dimension vector on the base field K;

S105. calculate inverse matrices of the reversible affine R and S, store (R⁻¹,S⁻¹) and other basic parameters as the private key, which will be used in the signature process;

S106. finally store (v, y, g(x)) in the memory and complete the offline step calculation.

S2, the online step for online signature generation and online signature verification; wherein the specific process of online signature generation is as follows:

S201. first, calculate the hash value h(m)∈K^{o} of the message m, and then calculate m′=h(m)−y, where K^{o} denotes the o dimension vector on the base field K=GF(q), and o denotes the number of oil variables;

S202. act inverse affine S⁻¹ to m′, get u=S⁻¹(m′), and obtain its related polynomial u(x);

S203. obtain the solution (\hat{x}₁, . . . , \hat{x}ₒ) of the central mapping oil variable by calculating u(x)*g(x), wherein g(x) is the polynomial form of the inverse matrix G⁻¹ of the circulant matrix G;

S204. splice the vinegar variable (v₁, . . . , vᵥ), which are selected in the offline calculation stage, and the solution (\hat{x}₁, . . . , \hat{x}ₒ) of the oil variable, to get \hat{x}=(x₁, . . . , xₙ), wherein n=o+v;

S205. act inverse affine R⁻¹ to \hat{x}, get s=R⁻¹(\hat{x}), output the signature s∈Kⁿ;

Among them, the specific process of online signature verification is as follows:

S206. the signer sends the message signature pair (m,s) to the verifier;

S207. the verifier uses the public key P to calculate whether P(s) is equal to h(m)−y to verify the correctness of the signature; if they are equal, the signature is legal; otherwise, the signature is illegal.

The abovementioned step S102 converts the central mapping equation of the unbalanced oil and vinegar signature, and decomposes into the online and offline calculation form, specifically comprises the following steps:

S102a. first unfold the unbalanced oil and vinegar central mapping equation and express it as:

$$\underbrace{{v}^{T} * {A}_{k} * v + {v}^{T} \cdot {α}_{k} + {c}_{k}}_{constant} + \underbrace{{v}^{T} * {B}_{k} * o + {β}_{k} \cdot o}_{linear in o} = {m}_{k} , \\ v ∈ {K}^{v} , o ∈ {K}^{o} , k = 1 , 2 , … o ;$$

S102b. let yₖ=(v^{T}*Aₖ*v+v^{T}·αₖ+cₖ),k∈[1, 2, . . . , o], substitute the vinegar variable into the oil and vinegar equation, then express the unbalanced oil and vinegar signature central mapping equation as Go=u:

$$\underbrace{( \begin{matrix}{v}^{T} * {B}_{1} + {β}_{1} \\ {v}^{T} * {B}_{2} + {β}_{2} \\ ⋮ \\ {v}^{T} * {B}_{o - 1} + {β}_{o - 1} \\ {v}^{T} * {B}_{o - 1} + {β}_{o - 1}\end{matrix} )}_{G} ( \begin{matrix}{o}_{1} \\ {o}_{2} \\ ⋮ \\ {o}_{o - 1} \\ {o}_{o}\end{matrix} ) = \underbrace{( \begin{matrix}{m}_{1} \\ {m}_{2} \\ ⋮ \\ {m}_{o - 1} \\ {m}_{0}\end{matrix} ) - ( \begin{matrix}{y}_{1} \\ {y}_{2} \\ ⋮ \\ {y}_{o - 1} \\ {y}_{o}\end{matrix} )}_{u} .$$

In the abovementioned step S103, the execution of circulating calculation method, the circulating calculation method specifically comprises the following steps:

S103a. first select the set of vinegar variables (v₁, . . . , vᵥ);

S103b. get the first row of the matrix G by calculating v*B₁+β₁, and then obtain the complete circulant matrix G by rotating (B₁, β₁);

S103c. write the polynomial form of the circulant matrix G, f(x)=Σᵢ₌ₒ^{o-1}lᵢxᵢ;

S103d. use an extended Euclidean algorithm to find the inverse element g(x) of f(x) on the polynomial ring K[x]/(x^{o}−1), and then re-present g(x) as the matrix form G⁻¹; if the inverse element g(x) does not exist, indicating that the matrix G is irreversible, then return to step S103a to re-select the vinegar variable v;

S103e. according to an effective vinegar variable v, calculate yₖ=(v^{T}*Aₖ*v+v^{T}·αₖ+cₖ)(k∈[1, . . . , o]) to get the constant term vector y.

The online and offline circulating unbalanced oil and vinegar signature method disclosed in the present invention is applied to a wireless sensor network at the same time as the signature scheme in the prior art, and Table 1 below shows the comparison results:

TABLE 1
Comparison table of the present invention with prior art

| | | | | | Key | | |
|---|---|---|---|---|---|---|---|
| | | Public | Private | | Generation | Signature | Verification |
| | Parameter | Key | Key | Signature | Period | Period | Period |
| Scheme | (o, v) | (KB) | (KB) | (bit) | (10³ cycles) | (10³ cycles) | (10³ cycles) |
| UOV | (33, 66) | 101.7 | 96.5 | 495 | 44,964 | 1,893 | 43 |
| Cyclic UOV | (33, 66) | 17.1 | 96.5 | 495 | 22,291,200 | 1,893 | 10 |
| MB UOV | (33, 66, d = 3) | 101.7 | 54.1 | 495 | 151,284 | 1,242 | 43 |
| NT UOV | (33, 66) | 101.7 | 67.9 | 495 | 136,814 | 1,287 | 43 |
| Present | (34, 65) | 101.7 | 53.9 | 495 | 139,472 | 252 | 43 |
| Invention | | | | | | | |

It can be seen from Table 1 that the online and offline circulating unbalanced oil and vinegar signature method disclosed in the present invention is optimal in signature time and private key size, and is more suitable for wireless sensor network with low performance but high latency requirements.

In summary, the abovementioned embodiment provides the online and offline circulating unbalanced oil and vinegar signature method. Under the premise of ensuring information security, the method decomposes the signature process into online and offline parts. Using the energy, which the wireless sensor device cannot store because of exceeding the capacity range at the peak of the energy collection, to calculate in the offline step, it makes full use of the characteristics of current wireless sensor devices that can collect energy to improve energy utilization. In addition, the signature scheme combines the use of the circulating calculation method, which greatly reduces the length of the key and shortens the period of the signature.

The abovementioned embodiments are preferred embodiments of the present invention, but the embodiments of the present invention are not limited to the above embodiments, and any other changes, modifications, substitutions, combinations, and simplifications that are made without departing from the spirit and scope of the invention should be equivalent replacement means, and are included in the protection scope of the invention.

It is claimed:

1. An online and offline circulating unbalanced oil and vinegar signature method, characterized in that the online and offline circulating unbalanced oil and vinegar signature method comprises:
offline step: before a signature message arrives, using an energy that cannot be stored at a peak of energy collection by a device to calculate in advance and store intermediate results, and in process, using a circulating calculation method to construct a central mapping matrix, and using a fast inversion method based on a circulant matrix to obtain an inverse matrix; the calculation process comprises: selecting secret parameters, calculating the central mapping matrix and its inverse matrix, generating a public key and a private key and storing calculation results;
online step: when the signature message arrives, completing a final signature in combination with the results stored in the offline step; the calculation process comprises: signature message preprocessing, signature operation, and signature verification.

2. The online and offline circulating unbalanced oil and vinegar signature method according to claim 1, characterized in that constructing the central mapping matrix by using the circulating calculation method comprises the following steps:
first, calculating a first row of a matrix G by v*B₁+β₁, where visa vinegar variable, B₁ is a cross-term coefficient of the vinegar variable and an oil variable, and β₁ is a linear term coefficient of the oil variable; then obtaining a complete circulant matrix G by rotating (B₁,β₁).

3. The online and offline circulating unbalanced oil and vinegar signature method according to claim 1, characterized in that obtaining the inverse matrix by using the fast inversion method based on the circulant matrix comprises the following steps:
first, writing a polynomial form f(x)=Σᵢ₌ₒ^{o-1}lᵢxᵢ of a circulant matrix G; then using an extended Euclidean algorithm to find an inverse element g(x) of f(x) on a polynomial ring K[x]/(x^{o}−1); finally, re-presenting g(x) as a matrix form G⁻¹.

4. The online and offline circulating unbalanced oil and vinegar signature method according to claim 1, characterized in that the offline step is used for offline key generation, as follows:
S101. first, according to a required security level, select a base field K=GF(q), the number of oil variables o, the number of vinegar variables v, and a reversible affine R and S, let n=o+v;
S102. convert a central mapping equation of the unbalanced oil and vinegar signature, and decompose into a form that can be calculated online and offline;
S103. perform a circulating calculation method, including selecting a vinegar vector v, calculate a circulant matrix G, and solve an inverse matrix G⁻¹ of G as a polynomial form g(x), and calculate a constant term vector y;
S104. calculate a composite map P=S [symbol] G [symbol] R [symbol] Kⁿ→K^{o} as a public key and store it for verifying a signature process, where Kⁿ→K^{o} denotes a representation of a mapping from n dimension vector to o dimension vector on the base field K;
S105. calculate inverse matrices of the reversible affine R and S, store (R⁻¹,S⁻¹) and other basic parameters as a private key, which will be used in the signature process;
S106. finally store (v, y, g(x)) in the memory and complete the offline step calculation.

5. The online and offline circulating unbalanced oil and vinegar signature method according to claim 1, characterized in that the online step is used for online signature generations and online signature verifications; wherein a specific process of online signature generations is as follows:
S201. first, calculate a hash value h(m)∈K^{o} of a message m, and then calculate m′=h(m)−y, where K^{o} denotes a o dimension vector on a base field K=GF(q), and o denotes the number of oil variables;
S202. act inverse affine S⁻¹ to m′, get u=S⁻¹(m′), and obtain its related polynomial u(x);
S203. obtain a solution (\hat{x}₁, . . . , \hat{x}ₒ) of a central mapping oil variable by calculating u(x)*g(x), wherein g(x) is a polynomial form of an inverse matrix G⁻¹ of a circulant matrix G;
S204. splice a vinegar variable (v₁, . . . , vᵥ), which are selected in the offline calculation stage, and the solution (\hat{x}₁, . . . , \hat{x}ₒ) of the oil variable, to get \hat{x}=(x₁, . . . , xₙ), wherein n=o+v;
S205. act inverse affine R⁻¹ to \hat{x}, get s=R⁻¹(\hat{x}), output a signature s∈Kⁿ;
Among them, a specific process of online signature verification is as follows:
S206. a signer sends a message signature pair (m,s) to a verifier;
S207. the verifier uses a public key P to calculate whether P(s) is equal to h(m)−y to verify a correctness of the signature; if they are equal, the signature is legal; otherwise, the signature is illegal.

6. The online and offline circulating unbalanced oil and vinegar signature method according to claim 4, characterized in that the step S102 converts the central mapping equation of the unbalanced oil and vinegar signature, and decomposes into an online and offline calculation form, specifically comprises the following steps:
S102a. first unfold an unbalanced oil and vinegar central mapping equation and express it as:
$$\underbrace{{v}^{T} * {A}_{k} * v + {v}^{T} \cdot {α}_{k} + {c}_{k}}_{constant} + \underbrace{{v}^{T} * {B}_{k} * o + {β}_{k} \cdot o}_{linear in o} = {m}_{k} , \\ v ∈ {K}^{v} , o ∈ {K}^{o} , k = 1 , 2 , … o ;$$
S102b. let yₖ=(v^{T}*Aₖ*+v^{T}·αₖ+cₖ),k∈[1,2, . . . , o], substitute the vinegar variable into the oil and vinegar equation, then express an unbalanced oil and vinegar signature central mapping equation as Go=u:
$$\underbrace{( \begin{matrix}{v}^{T} * {B}_{1} + {β}_{1} \\ {v}^{T} * {B}_{2} + {β}_{2} \\ ⋮ \\ {v}^{T} * {B}_{o - 1} + {β}_{o - 1} \\ {v}^{T} * {B}_{o - 1} + {β}_{o - 1}\end{matrix} )}_{G} ( \begin{matrix}{o}_{1} \\ {o}_{2} \\ ⋮ \\ {o}_{o - 1} \\ {o}_{o}\end{matrix} ) = \underbrace{( \begin{matrix}{m}_{1} \\ {m}_{2} \\ ⋮ \\ {m}_{o - 1} \\ {m}_{0}\end{matrix} ) - ( \begin{matrix}{y}_{1} \\ {y}_{2} \\ ⋮ \\ {y}_{o - 1} \\ {y}_{o}\end{matrix} )}_{u} .$$

7. The online and offline circulating unbalanced oil and vinegar signature method according to claim 4, characterized in that the step S103, in the execution of circulating calculation method, the circulating calculation method specifically comprises the following steps:
S103a. first select a set of vinegar variables (v₁, . . . , vᵥ);
S103b. get a first row of the matrix G by calculating v*B₁+β₁, and then obtain a complete circulant matrix G by rotating (B₁,β₁);
S103c. write a polynomial form of the circulant matrix G, f(x)=Σᵢ₌ₒ^{o-1}lᵢxᵢ;
S103d. use an extended Euclidean algorithm to find an inverse element g(x) of f(x) on a polynomial ring K[x]/(x^{o}−1), and then re-present g(x) as a matrix form G⁻¹; if an inverse element g(x) does not exist, indicating that the matrix G is irreversible, then return to step S103a to re-select the vinegar variable v;
S103e. according to an effective vinegar variable v, calculate yₖ=(v^{T}*Aₖ*v+v^{T}·αₖ+cₖ)(k∈[1, . . . , o]) to get a constant term vector y.
